(19) United States
(12) Patent Application Publication
(10) Pub. No.: US 2026/0285353 A1
(43) Pub. Date: Sep. 24, 2026

(54) DETECTING WRONG WAY DRIVING OF A VEHICLE

(71) Applicant: Robert Bosch GmbH, Stuttgart (DE)

(72) Inventors: Martin Richter, Belleville, MI (US); Courtney L. Lawson, Livonia, MI (US); Christopher J. Kelly, LaSalle (CA); Troy A. McCormick, Milford, MI (US)

(21) Appl. No.: 19/087,046

(22) Filed: Mar. 21, 2025

(51) Int. Cl. B60W 50/16; B60W 30/18; B60W 50/14; B60W 60/00

(52) U.S. Cl. CPC B60W 50/16; B60W 30/18163; B60W 60/0015; B60W 2050/143; B60W 2050/146; B60W 2420/403; B60W 2420/408; B60W 2520/06; B60W 2552/53; B60W 2556/40; B60W 2556/50; B60W 2556/65

(57) ABSTRACT

A system for detecting wrong way driving of a vehicle. The system includes an electronic processor. The electronic processor is configured to receive data from one or more sensors, receive map data, and determine, based on the sensor data and the map data, a location of the vehicle and a direction of travel of the vehicle. The electronic processor is also configured to determine a correct direction associated with the determined location and determine whether the direction of travel of the vehicle matches the correct direction. The electronic processor is further configured to, in response to determining the direction of travel of the vehicle does not match the correct direction, determine whether a driving situation of the vehicle matches one or more edge cases and, in response to determining that the driving situation does not match one or more edge cases, generate a warning.

### SUMMARY

Among other things, implementations described herein provide a system and method for detecting when a vehicle is driving in the wrong direction. In some instances, implementations described herein allow a warning to be provided to a driver or a corrective action to be taken when a vehicle is traveling in a wrong direction because the location of a vehicle may be determined with great accuracy (for example, an accuracy of +/−30 centimeters) using, in some instances, a GPS location, a road signature, data from an inertial measurement unit, or a combination of the foregoing. In one example, a warning is provided to a driver when a vehicle travels the wrong way on a one-way road and/or when a vehicle travels the wrong way in a multi-lane road where opposite direction lanes are separated by a centerline, a middle lane, or a median. In some implementations, a warning is provided when a vehicle turns in an incorrect direction (for example, turning left at an intersection where no left turn is allowed). To help prevent unnecessary warnings from being provided to a driver, in some examples the current driving situation of the vehicle is assessed to determine whether the current driving situation matches an edge case (for example, a performing passing maneuver or traveling a detour route).

One example implementation provides, a system for detecting wrong way driving of a vehicle. The system includes an electronic processor. The electronic processor is configured to receive data from one or more sensors, receive map data, and determine, based on the sensor data and the map data, a location of the vehicle and a direction of travel of the vehicle. The location includes a lane of a road that the vehicle is traveling in. The electronic processor is also configured to determine a correct direction associated with the determined location and determine whether the direction of travel of the vehicle matches the correct direction. The electronic processor is further configured to, in response to determining the direction of travel of the vehicle does not match the correct direction, determine whether a driving situation of the vehicle matches one or more edge cases and, in response to determining that the driving situation does not match one or more edge cases, generate a warning.

Another example implementation provides, a method for detecting wrong way driving of a vehicle. The method includes receiving data from one or more sensors, receiving map data, and determining, based on the sensor data and the map data, a location of the vehicle and a direction of travel of the vehicle. The location includes a lane of a road that the vehicle is traveling in. The method further includes determining a correct direction associated with the determined location and determining whether the direction of travel of the vehicle matches the correct direction. The method also includes, in response to determining the direction of travel of the vehicle does not match the correct direction, determining whether a driving situation of the vehicle matches one or more edge cases and, in response to determining that the driving situation does not match one or more edge cases, generating a warning.

### BRIEF DESCRIPTION OF THE DRAWINGS

FIG. 1 is a block diagram of an example system for detecting wrong way driving of a vehicle, in accordance with some implementations.

FIG. 2 is a block diagram of an example electronic controller for implementing the method of FIG. 3, in accordance with some implementations.

FIG. 3 is a flowchart of an example method for detecting wrong way driving of a vehicle, in accordance with some implementations.

### DETAILED DESCRIPTION

Before any implementations, examples, aspects, and features are explained in detail, it is to be understood that they are not limited in their application to the details of construction and the arrangement of components set forth in the following description or illustrated in the following drawings. Other implementations, examples, aspects, and features are possible, and they are capable of being practiced or of being carried out in various ways.

For ease of description, some or all of the example systems presented herein are illustrated with a single exemplar of each of its component parts. Some examples may not describe or illustrate all components of the systems. Other examples may include more or fewer of each of the illustrated components, may combine some components, or may include additional or alternative components.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some implementations, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations. To reiterate, those electronic processors and processing may be distributed.

In this document relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus.

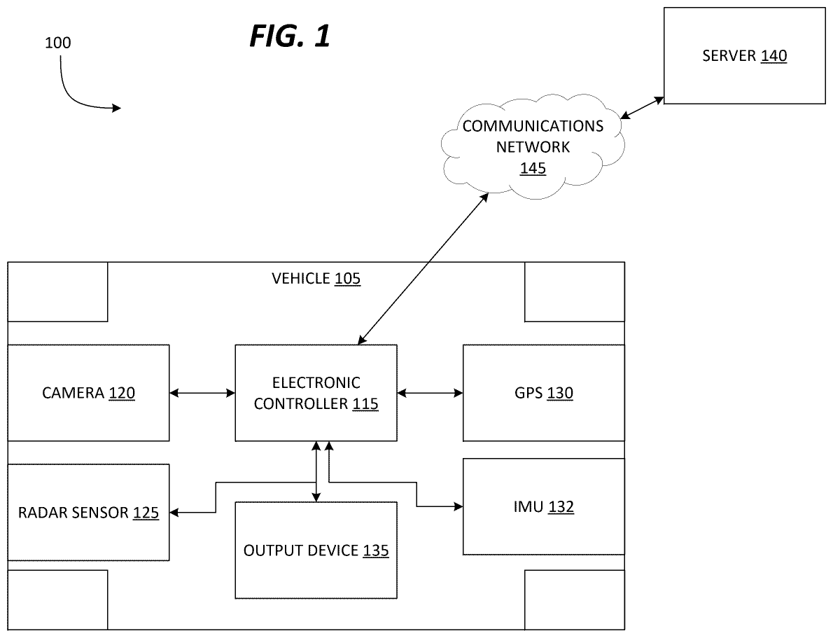

FIG. 1 illustrates an example system 100 for detecting wrong way driving of a vehicle. In FIG. 1 the system 100 includes a vehicle 105. While the vehicle 105 is illustrated in FIG. 1 as being a four-wheel vehicle, it should be understood that the vehicle 105 may be a two wheeled vehicle, a three wheeled vehicle, a six wheeled vehicle or the like. The vehicle 105 may include one or more controllers. The vehicle 105 illustrated in FIG. 1 includes an electronic controller 115. In some implementations, the functionality described as being implemented by the electronic controller 115 is implemented by multiple electronic controllers.

The vehicle 105 may also include one or more sensors. In the example illustrated in FIG. 1, the vehicle 105 includes a camera 120, a radar sensor 125, a global positioning system (GPS) 130, and an inertial measurement unit (IMU) 132. In some implementations, the IMU 132 includes one or more accelerometers, one or more gyroscopes, a combination of the foregoing, or the like. In some implementations, the IMU 132 is a 6-dimensional IMU. In some implementations, the vehicle 105 may include fewer or additional sensors. For example, the vehicle 105 may also include a LIDAR sensor or an ultrasonic sensor (not illustrated). In another example, the vehicle 105 may include multiple cameras and/or radar sensors rather than the single camera 120 and single radar sensor 125 illustrated in FIG. 1.

The vehicle 105 may also include an output device 135. The output device 135 is, for example, a heads-up display including a screen. The output device 135 may also be a speaker or a haptic device. In another example, the output device 135 may be a warning light.

The components of the vehicle 105, are electrically and communicatively coupled to each other via direct or indirect connections or by or through one or more control or data buses, which enable communication therebetween. In some instances, the bus is a Controller Area Network (CAN™) bus. In some instances, the bus is an automotive Ethernet™, a FlexRay™ communications bus, or another suitable bus. In alternative instances, some or all the components of the vehicle 105 may be communicatively coupled using suitable wireless modalities (for example, Bluetooth™ or near field communication connections).

The system 100 may also include a server 140. The server 140 may be configured to receive data from a plurality of vehicles. The server 140 may combine the data from the plurality of vehicles to create a high definition (HD) map. For example, the server 140 may receive a road signature from a vehicle of the plurality of vehicles, along with a location of the vehicle and a direction of travel for the vehicle. Based on the location of the vehicle, the direction of travel for the vehicle, and the road signature, the server 140 may aggregate the road signature and direction of travel with other received road signatures and directions of travel to create the HD map. The location of the vehicle may be determined based on a GPS location of the vehicle and data from an IMU included in the vehicle. In some implementations, the GPS location of the vehicle is corrected by comparing the known location of one or more reference stations to the GPS location of the one or more reference stations. A road signature may include features of the road determined based on data from one or more cameras included in a vehicle, one or more radar sensors included in the vehicle, or both the cameras and radar sensors included in the vehicle. For example, a road signature may include lane geometry, lane width, semantic information (for example, road signs), road boundaries, radar reflection points, locations of three dimensional (3D) objects in the environment of the vehicle, a combination of the foregoing, or the like. In some implementations, the server 140 may only rely on road signatures received within a predetermined period of time (for example, the most previous 10 days) to create the HD map.

In some implementations, the vehicle 105 sends a road signature to the server 140 that is reduced or filtered. The road signature sent to the server 140 may be filtered to conserve bandwidth in the communications network 145 and limit the amount of data stored by the server 140. For example, if the road signature incudes data from one or more radar sensors included in the vehicle (for example, the radar sensor 125 of the vehicle 105), the electronic processor included in the electronic controller of the vehicle (for example, the electronic processor 200, described below) filters from the road signature, points captured by the radar sensor 125 that have a signal value below a predetermined threshold signal value, a reflection value below a predetermined threshold reflection value, a quality value below a predetermined threshold quality value, a combination of the foregoing, or the like. In another example, when the electronic processor 200 determines that a cluster of points or an array or points representing an object contains more points than are needed to represent the object, the electronic processor 200 filters points that are unnecessary to represent the object from the road signature.

To, for example, conserve bandwidth of the communications network 145, vehicles may be configured to send a road signature to the server 140 when a predetermined threshold is reached. For example, a vehicle 105 may be configured to send a road signature to the server 140 when the vehicle 105 has traveled at least a minimum distance (for example, 0.5 meters) from the location the vehicle 105 was at when the vehicle sent the most previous road signature to the server 140. In another example, the vehicle 105 sends the road signature to the server 140 when a maximum amount of time (for example, 5 seconds) has passed since the most previous road signature was sent to the server 140. In yet another example, the vehicle 105 sends the road signature to the server 140 when the message containing the road signature reaches a maximum size (for example, 4 kilobytes).

The HD map may contain a planning layer, a localization layer, and a behavior layer. The planning layer may include road and lane models (for example, road and lane geometry, road and lane topology, and semantic information (i.e. traffic signs)). The behavior layer may include an average path driven, direction of travel, speed profiles, braking/stopping hotspots, lane changing hotspots, lane and road mutations, or the like. The localization layer may enable highly accurate vehicle locations to be determined using 3D landmarks and may include landmarks (for example, lane markings, traffic signs, and the like) captured using cameras and radar sensors. The HD map may include additional layers other than those described herein.

In some implementations, the vehicle 105 may communicate with external computing devices (for example, the server 140) via the communications network 145. In some implementations, the communications network 145 is a communications network including wireless connections, wired connections, or combinations of both. The communications network 145 may be implemented using a wide area network, for example, the Internet, a Long-Term Evolution (LTE) network, a 4G network, 5G network, or one of their successors, and one or more local area networks, for example, a Bluetooth™ network or Wi-Fi network, and combinations or derivatives thereof.

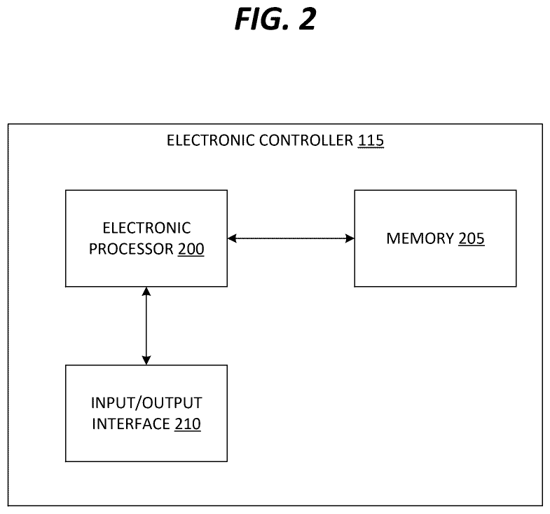

FIG. 2 provides an illustrative example of the components of the electronic controller 115. In the example illustrated in FIG. 2, the electronic controller 115 includes an electronic processor 200 (for example, a microprocessor, application specific integrated circuit, etc.), a memory 205, and a communication interface 210. The memory 205 may be made up of one or more non-transitory computer-readable media. The memory 205 can include combinations of different types of memory, such as read-only memory (“ROM”), random access memory (“RAM”), electrically erasable programmable read-only memory (“EEPROM”), flash memory, or other suitable memory devices. The electronic processor 200 is coupled to the memory 205 and the communication interface 210. The electronic processor 200 sends and receives information (for example, from the memory 205 and/or the communication interface 210) and processes the information by executing one or more software instructions or modules, capable of being stored in the memory 205, or another non-transitory computer readable medium. The software can include firmware, one or more applications, program data, filters, rules, one or more program modules, and other executable instructions. The electronic processor 200 is configured to retrieve from the memory 205 and execute, among other things, software for performing methods as described herein. The communication interface 210 transmits and receives information from devices external to the electronic controller 115 (for example, components of the vehicle 105 (for example, the camera 120, radar sensor 125, GPS 130, IMU 132, and output device 135) and the server 140).

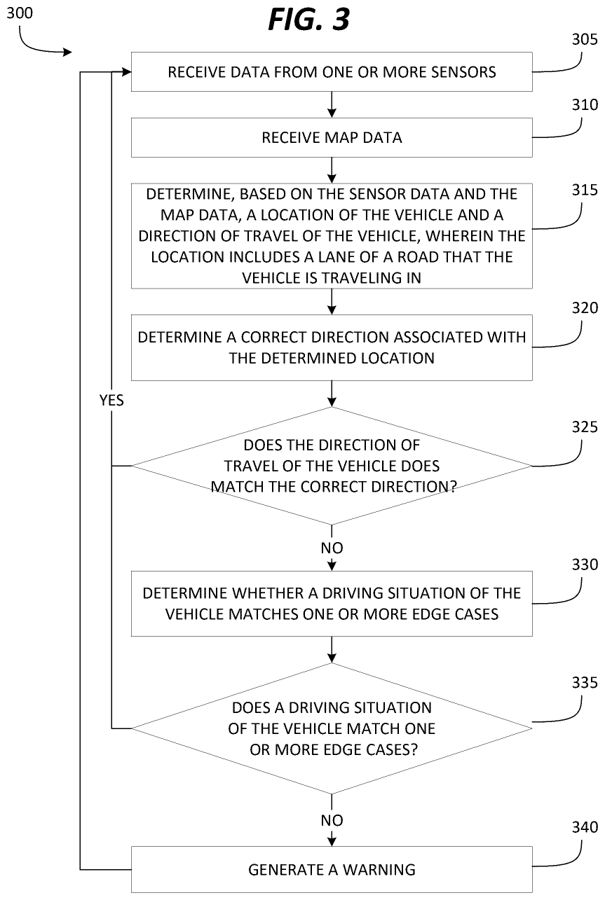

FIG. 3 is a flowchart of an example method 300 for detecting wrong way driving of a vehicle (for example, the vehicle 105). In some implementations, the method 300 begins at block 305 when the electronic processor 200 receives data from one or more sensors (for example, the radar sensor 125, the camera 120, the GPS 130, the IMU 132, or a combination of the foregoing). At block 310, the electronic processor 200 receives map data. The map data may be the HD map or a portion of the HD map determined by the server 140.

At block 315, the electronic processor 200 determines, based on the sensor data and the map data, a location of the vehicle 105 and a direction of travel of the vehicle 105. The determined location of the vehicle 105 includes a lane of a road that the vehicle 105 is traveling in. Therefore, the location of the vehicle 105 determined by the electronic processor 200 is more accurate than the location of the vehicle 105 determined by the GPS 130.

In some implementations, when the vehicle 105 turns on or is started up, the electronic processor 200 determines a general location of the vehicle 105 based on data from the GPS 130. In some implementations, the electronic processor 200 also utilizes data from the IMU 132 to determine the general location of the vehicle 105. In some implementations, the GPS location of the vehicle 105 is corrected by comparing the known location of one or more reference stations to the GPS location of the one or more reference stations. The corrected GPS location may be received by the vehicle 105 from a remote computing device such as the server 140. The electronic processor 200 may determine relevant map data based on the general location of the vehicle 105. In some implementations, the electronic processor 200 sends a general location of the vehicle 105 to the server 140 along with a request for map data associated with the general location. The electronic processor 200 may receive the map data from the server 140 in response to the request. In other implementations, the electronic processor 200 may periodically receive map data (for example, updated HD map data) from the server 140 and store the received map data in the memory 205. The electronic processor 200 may receive or retrieve the map data associated with the general location of the vehicle 105 from the memory 205. In some implementations, when the vehicle 105 turns on or starts up, a GPS location of the vehicle 105 is used by the electronic processor 200 to retrieve relevant map data from memory 205. When the electronic processor 200 subsequently retrieves relevant map data from the memory 205, the electronic processor 200 may retrieve the relevant map data without utilizing the GPS location of the vehicle 105.

In some implementations, the data received from the radar sensor 125 and the camera 120 is used by the electronic processor 200 to determine a road signature associated with the current location of the vehicle 105. As mentioned above, the road signature may include the location of stationary 3D objects and lane markings relative to the vehicle 105 in its current location. In some implementations, the road signature associated with the current location of the vehicle 105 may include the position of the object, lane marking, or the like relative to the vehicle 105. The electronic processor 200 may compare the road signature associated with the current location of the vehicle 105 to the relevant map data (specifically, the data included in the localization layer of the relevant map data). By comparing the road signature associated with the current location of the vehicle 105 to a road signature included in the relevant map data, the electronic processor 200 may determine the location of the vehicle 105 including the lane that the vehicle 105 is travelling in. In some implementations, the road signature included in the map data includes, for each object, lane marking, and the like, an ID, a latitude, and a longitude.

In one example, the electronic processor 200 compares the location of one or more objects included in the environment of the vehicle 105 to the location of the one or more objects included in the road signature of the relevant map data to determine a distance between locations of objects relative to an average path driven included in road signature of the relevant map data and locations of objects relative to the vehicle 105 in the determined road signature. Based on the comparison of the locations, the electronic processor 200 may determine the location of the vehicle 105. The locations of the objects in the environment and the road signature may be represented as a distance between the object and a vehicle (for example, lateral and longitudinal distance). For example, when the lateral distance from a guardrail to the vehicle 105 is 1.5 meters and the lateral distance to the guardrail in the road signature is 1 meter, the electronic processor 200 may determine that the vehicle 105 is 0.5 meters offset from the center of the lane that the vehicle 105 is traveling in.

In some implementations, the direction of travel of the vehicle 105 is determined based on changes in longitudinal distances between the vehicle 105 and objects included in the environment of the vehicle 105. For example, if the longitudinal distance between the vehicle 105 and a lamp post included in the environment is 3 meters at a first time and is 1.5 meters at a second later time, the electronic processor 200 determines that the vehicle is traveling towards the lamp post.

At block 320, the electronic processor 200 determines a correct direction associated with the determined location. For example, the electronic processor 200 determines the correct direction based on the data included in the behavior layer of the relevant map data.

At block 325, the electronic processor 200 determines whether the direction of travel of the vehicle 105 matches the correct direction. In response to determining that the direction of travel of the vehicle 105 matches the correct direction, the electronic processor 200 may cease performing the current iteration of the method 300 and proceed to block 305 to begin the next iteration of the method 300.

In response to determining that the direction of travel of the vehicle 105 does not match the correct direction, the electronic processor 200, at block 330, determines whether a driving situation of the vehicle 105 matches one or more edge cases. For example, the one or more edge cases may include the vehicle 105 performing a passing maneuver and the vehicle 105 traveling a detour route. In some implementations, the electronic processor 200 determines that the vehicle 105 is performing a passing maneuver when the vehicle 105 is traveling faster than a second vehicle traveling in the same direction as the vehicle 105 in a lane next to the vehicle 105. In some implementations, the electronic processor 200 utilizes an activation of a turn signal of the vehicle 105 to determine whether a vehicle is performing a passing maneuver. In some implementations, the electronic processor 200 may only determine that the vehicle 105 is performing a passing maneuver when further criteria are met. For example, the electronic processor 200 may only determine that the vehicle 105 is performing a passing maneuver when the passing maneuver is legal (for example, the centerline of the road is dashed). In some implementations, the electronic processor 200 determines whether the vehicle 105 is traveling a detour route (for example, a detour route established by a construction crew or law enforcement) by determining whether one or more detour signs or signals are present. A detour sign or signal may include, for example, a person signaling using flags, flares, or the like, a road sign, delineator barrels, delineator posts, a combination of the foregoing, or the like.

In some implementations, edge cases include traveling in a flex lane, traveling in a parking garage, traveling on a stacked highway, a combination of the foregoing, or the like. Flex lanes are also known as a time dependent express lanes and the correct direction of travel for such lanes may change depending on the time of day. For example, during the morning hours, the flex lane may be available to vehicles traveling towards an urban area and during the evening hours, the flex lane may be available to vehicles traveling away from the urban area. In one instance, the electronic processor 200 may determine that the vehicle 105 is traveling in a correct direction in a flex lane when the vehicle 105 is traveling at a time of day associated with the direction of travel of the vehicle 105. For example, the electronic processor 200 may determine, based on the map data, that at 8 am-10 am the correct direction of travel for the flex lane is east bound and because the vehicle 105 is traveling eastbound in the flex lane at 9:30 am the driving situation matches an edge case.

In another instance, a flex lane may be altered by moving a barrier. For example, when a sporting event at a stadium ends, a barrier on a road leading from the stadium may be moved to create one or more additional flex lanes to accommodate an increased amount of traffic traveling away from the stadium. In such instances, the electronic processor 200 determines that the driving situation of the vehicle 105 matches an edge case when the barrier is in the expected location relative to the vehicle 105 (for example, in the United States, when the barrier is on the left hand side of the vehicle 105).

The electronic processor 200 may determine that the driving situation of the vehicle 105 matches an edge case of traveling in a parking garage or a stacked highway when 1) sensor data (from, for example, the radar sensor 125) indicates a drivable structure is located above the vehicle 105, 2) the GPS location of the vehicle 105 indicates the elevation of the vehicle 105 is above or below ground level, or both 1) and 2).

In response to determining that the driving situation does not match one or more edge cases, at block 340, the electronic processor 200, generates a warning. The warning may be a visual warning, an aural warning, a haptic warning, a combination of the foregoing, and the like output via the output device 135. For example, generating the visual warning may include illuminating a warning light on a dashboard of the vehicle 105, displaying a warning message via a screen of a heads-up display, a combination of the foregoing, or the like. The aural warning may include a spoken warning message, an alarm sounding, or the like.

In some implementations, the electronic processor 200, generates a warning once the vehicle 105 has traveled in the incorrect direction for a predetermined amount of time (for example, 1 or 2 seconds).

In some implementations, the electronic processor 200 may also be configured to generate a warning when the vehicle 105 may make or begins to make a wrong way turn. For example, the electronic processor 200 may determine at block 315, that a vehicle 105 is in a far left lane of a road and intending or not intending to turn left (a direction of travel) based on whether the left turn signal of the vehicle 105 is activated. At block 320, when the electronic processor 200 determines, that the vehicle 105 is at an intersection, the electronic processor 200 may determine based on, for example, the behavioral layer of the map data, whether the correct direction of travel is to turn left, to continue straight, or to either turn left or continue straight. In some implementations, the electronic processor 200 determines whether the vehicle 105 is at an intersection using data from the one or more sensors included in the vehicle 105 and performing image or object recognition based on the data. In some implementations, the electronic processor 200, confirms the correct direction of travel using one or more road signs included in image data captured by the camera 120. For example, the electronic processor 200 may determine that the correct direction of travel is straight when the image data includes a road sign indicating that no left turns may be made from the lane that the vehicle 105 is in. When, at block 325, the direction of travel of the vehicle 105 does not match the correct direction (for example, the vehicle 105 is signaling a left turn and is in a lane that does not allow a left turn), the electronic processor 200 determines, at block 335, whether the driving situation matches one or more edge cases (for example, whether the vehicle 105 is traveling on a detour). When the driving situation does not match an edge case, the electronic processor 200 generates a warning indicating that the vehicle 105 is about to make an illegal maneuver (for example, turning left from a lane that does not allow left turn). As described above, the warning may be a visual warning, an aural warning, a haptic warning, a combination of the foregoing, and the like output via the output device 135.

In some implementations, in addition to generating the warning, the electronic processor 200 automatically controls the vehicle 105 (for example, a braking system, a steering system, and an accelerator of the vehicle 105) to move the vehicle 105 to a safe location. The electronic processor 200 may only control the vehicle 105 to move the vehicle 105 to a safe location when it is safe to move the vehicle 105. For example, the electronic processor 200 may only move the vehicle 105 to a safe location when the path from the vehicle's current position to the safe location is free of obstructions. A safe location is, for example, a lane in which the direction of travel of the vehicle 105 is correct, a shoulder of the road, a parking lot, or the like.

In some implementations, once the warning is generated and/or the vehicle 105 has moved to a safe location, the electronic processor 200 may procced to block 305 to perform another iteration of the method 300.

Thus, examples, aspects, and features herein provide, among other things, systems and methods for detecting wrong way driving of a vehicle.

What is claimed is:

1. A system for detecting wrong way driving of a vehicle, the system comprising:
an electronic processor, the electronic processor configured to:
receive data from one or more sensors;
receive map data;
determine, based on the sensor data and the map data, a location of the vehicle and a direction of travel of the vehicle, wherein the location includes a lane of a road that the vehicle is traveling in;
determine a correct direction associated with the determined location;
determine whether the direction of travel of the vehicle matches the correct direction; and
in response to determining the direction of travel of the vehicle does not match the correct direction,
determine whether a driving situation of the vehicle matches one or more edge cases; and
in response to determining that the driving situation does not match one or more edge cases, generate a warning.

2. The system according to claim 1, the electronic processor further configured to:
in response to determining that the driving situation does not match one or more edge cases, automatically control the vehicle to move the vehicle to a safe location.

3. The system according to claim 1, wherein the one or more sensors include at least one selected from the group consisting of a camera, a radar sensor, a global positioning system, and an inertial measurement unit.

4. The system according to claim 1, wherein the one or more edge cases include performing a passing maneuver and determining whether the vehicle is performing a passing maneuver includes:
determining that the vehicle is performing a passing maneuver when the vehicle is traveling faster than a second vehicle traveling in a same direction as the vehicle in a lane next to the vehicle.

5. The system according to claim 1, the one or more edge cases include traveling a detour route and determining whether the vehicle is traveling a detour route includes:
determining the vehicle is traveling on a detour when one or more detour signs or signals are present.

6. The system according to claim 1, wherein the electronic processor is configured to determine, based on the sensor data and map data, a location of the vehicle and a direction of travel of the vehicle by:
when the vehicle starts,
determining a general location of the vehicle based on data from a GPS sensor;
based on the general location, determining relevant map data;
determining a road signature based on the data from the one or more sensors; and
comparing the determined road signature to a road signature included in the relevant map data to determine the location of the vehicle.

7. The system according to claim 1, wherein the system further includes a server, the server configured to:
determine the map data based on road signature data received from a plurality of vehicles.

8. The system according to claim 7, wherein the server is further configured to:
determine the correct direction based on data from a plurality of vehicles traveling through the determined location; and
include the correct direction in the map data.

9. The system according to claim 1, wherein the system further includes a server and the electronic processor is further configured to:
determine a filtered road signature; and
send the filtered road signature to the server when a predetermined threshold is reached.

10. The system according to claim 1, wherein the electronic processor is configured to determine, based on the sensor data and map data, a location of the vehicle and a direction of travel of the vehicle by:
determining relevant map data;
determining a road signature based on the data from the one or more sensors;
comparing the determined road signature to a road signature included in the relevant map data to determine a distance between locations of objects relative to an average path driven included in road signature of the relevant map data and locations of objects relative to the vehicle in the determined road signature; and
based on the distance, determining the location of the vehicle.

11. A method for detecting wrong way driving of a vehicle, the method comprising:
receiving data from one or more sensors;
receiving map data;
determining, based on the sensor data and the map data, a location of the vehicle and a direction of travel of the vehicle, wherein the location includes a lane of a road that the vehicle is traveling in;
determining a correct direction associated with the determined location;
determining whether the direction of travel of the vehicle matches the correct direction; and
in response to determining the direction of travel of the vehicle does not match the correct direction,
determining whether a driving situation of the vehicle matches one or more edge cases; and
in response to determining that the driving situation does not match one or more edge cases, generating a warning.

12. The method according to claim 11, the method further comprising:
in response to determining that the driving situation does not match one or more edge cases, automatically controlling the vehicle to move the vehicle to a safe location.

13. The method according to claim 11, wherein the one or more sensors include at least one selected from the group consisting of a camera, a radar sensor, a global positioning system, and an inertial measurement unit.

14. The method according to claim 11, the one or more edge cases include performing a passing maneuver and determining whether the vehicle is performing a passing maneuver includes:
determining that the vehicle is performing a passing maneuver when the vehicle is traveling faster than a second vehicle traveling in a same direction as the vehicle in a lane next to the vehicle.

15. The method according to claim 11, the one or more edge cases include traveling a detour route and determining whether the vehicle is traveling a detour route includes:
determining the vehicle is traveling on a detour when one or more detour signs or signals are present.

16. The method according to claim 11, wherein determining, based on the sensor data and map data, a location of the vehicle and a direction of travel of the vehicle includes:
determining a general location of the vehicle based on data from a GPS sensor;
based on the general location, determining relevant map data;
determining a road signature based on the data from the one or more sensors; and
comparing the determined road signature to a road signature included in the relevant map data to determine the location of the vehicle.

17. The method according to claim 11, the method further comprising:
determining the map data based on road signature data received from a plurality of vehicles.

18. The method according to claim 17, the method further comprising:
determining the correct direction based on data from a plurality of vehicles traveling through the determined location; and
including the correct direction in the map data.

19. The method according to claim 11, the method further comprising:
determining a filtered road signature; and
sending the filtered road signature to a server when a predetermined threshold is reached.

20. The method according to claim 11, wherein determining, based on the sensor data and map data, a location of the vehicle and a direction of travel of the vehicle includes:
determining relevant map data;
determining a road signature based on the data from the one or more sensors;
comparing the determined road signature to a road signature included in the relevant map data to determine a distance between locations of objects relative to an average path driven included in road signature of the relevant map data and locations of objects relative to the vehicle in the determined road signature; and
based on the distance, determining the location of the vehicle.
